(19) United States
(12) Patent Application Publication
(10) Pub. No.: US 2023/0052539 A1
(43) Pub. Date: Feb. 16, 2023

(54) ALKALI METAL MATERIALS

(71) Applicant: SIGMA LITHIUM LIMITED, Abingdon Oxfordshire (GB)

(72) Inventors: Vladimir KOLOSNITSYN, Ufa (RU); Elena KARASEVA, Ufa (RU); Gleb IVANOV, Oxford Oxfordshire (GB)

(73) Assignee: SIGMA LITHIUM LIMITED, Abingdon Oxfordshire (GB)

(21) Appl. No.: 17/792,466

(22) PCT Filed: Jan. 13, 2021
(86) PCT No.: PCT/EP2021/050593

§ 371 Date: Jul. 13, 2022

(30) Foreign Application Priority Data
Jan. 13, 2020 (GB) 2000467.7

(51) Int. Cl. H01M 4/36; H01M 4/38; H01M 4/62; H01M 4/1395; H01M 4/134; H01M 4/04

(52) U.S. Cl. CPC H01M 4/366; H01M 4/382; H01M 4/628; H01M 4/1395; H01M 4/134; H01M 4/04; H01M 2004/021

(57) ABSTRACT

There is disclosed a method of making a surface-modified alkali metal material for electrochemical use, the method comprising bringing a barrier agent into frictional contact with an alkali metal substrate to form a tribochemical barrier layer on the substrate. Also disclosed is a surface-modified alkali metal material for electrochemical use, the material comprising an alkali metal substrate bearing a tribochemical barrier layer.

### TECHNICAL FIELD

This invention relates to surface-modified alkali metal materials. In particular, though not exclusively, this invention relates to a method of making a surface-modified alkali metal material for electrochemical use, to surface-modified lithium materials for electrochemical use, and to an electrode, electrode assembly or electrochemical cell comprising the materials.

### BACKGROUND

Metallic lithium is known to be a potentially useful electrode material, since it has low electrode potential (3.05V against Normal Hydrogen Electrode) and high electrochemical equivalent (3,884 Ah/g). It is widely used in primary cells.

However, metallic lithium has limited application in secondary cells because of the formation of finely dispersed residues which do not have electric contact with the bulk of electrode metallic lithium. Such residues take the form of dendritic and mossy metallic lithium and do not participate in electrochemical reactions.

The formation of dispersed residues takes place during charge and discharge of the cell. In practice, formation of finely dispersed lithium leads to a number of negative effects such as quick battery capacity fade and possible internal shorts that could result in fire (X. B. Cheng, et al., Toward Safe Lithium Metal Anode in Rechargeable Batteries: A Review, Chem. Rev. 117 (2017), 10403-10473 DOI: 10.1021/acs.chemrev.7b00115).

It may be possible to avoid or mitigate formation of finely dispersed lithium residues by providing a special coating on the surface of a metallic lithium electrode. Such coatings may be referred to as barrier or protection layers. Barrier layers prevent or mitigate formation of finely dispersed lithium, whilst still permitting electrochemical reactions.

A range of materials can be used as barrier layers such as lithium alloys and solid-state lithium ion conductive coatings of different types: polymer, ceramic, polymer-ceramic, etc.

Barrier layers on metallic lithium can be formed by a variety of methods such as thermal deposition, magnetron sputtering, chemical solution deposition, polymerisation, etc. The choice of method is determined by the desired material properties of the barrier layer. The method itself must provide formation of a layer with good coverage and adhesion to metallic lithium.

U.S. Pat. No. 6,911,280 discloses a lithium electrode protected by a solid electrolyte layer of LiPON, produced by spraying lithium phosphate or by surface treatment of Li with phosphoric acid. Two other documents, RU 2 579 357 and RU 2 596 023 C1 describe lithium electrodes with sprayed layers on lithium made of Si, Ge, C, Al and Au. Barrier layers on the lithium electrode in these cases were produced by vacuum sputtering.

There is also a disclosure in the prior art of an anode material made of metallic foil with contact tabs so that metallic lithium can be either sprayed or rolled on its surface, optionally followed by coating the metallic lithium with a barrier layer (RU 2 596 023 C1).

Finally, there is also known a method of forming a barrier layer on the surface of a lithium electrode by magnetron vacuum sputtering of a material chosen from the following group: Si, Ge, C, Al, Au. (RU 2 579 357 C1).

Nevertheless, there remains a need in the art for lithium (and indeed other alkali metal) electrode materials comprising effective and cost-efficient protective/barrier layers.

### SUMMARY OF THE INVENTION

From one aspect, the invention provides a method of making a surface-modified alkali metal material for electrochemical use, the method comprising bringing a barrier agent into frictional contact with an alkali metal substrate to form a tribochemical barrier layer on the substrate.

It has been found that barrier layers formed in this manner are effective and cost- and energy-efficient to produce.

The field of tribochemistry is concerned with chemical and physiochemical changes of matter due to the influence of mechanical energy. Tribochemical mechanisms are manifold, highly complex, interrelated and not well understood (Kalin, Mitjan. “On the Evaluation of Thermal and Mechanical Factors in Low-Speed Sliding.” Tribology of Mechanical Systems: A Guide to Present and Future Technologies. Ed. Jože Vižintin, Mitjan Kalin, Kuniaki Dohda, and Said Jahanmir. ASME Press, 2004.).

The term “tribochemical barrier layer” is used herein to refer to an adherent coating that results from frictional contact of the barrier agent with the substrate. The barrier layer may be formed as a result of mechanical or chemical phenomena, or a combination thereof.

The barrier layer permits electrochemical reactions with the alkali metal substrate during electrochemical use, whilst mitigating or preventing the formation of dispersed residues of the alkali metal substrate (in particular in the context of a secondary cell).

From another aspect, the invention comprises a surface-modified alkali metal material obtainable by any method in accordance with the invention.

From yet another aspect, the invention provides a surface-modified alkali metal material for electrochemical use, the material comprising an alkali metal substrate bearing a tribochemical barrier layer.

From still another aspect, the invention comprises an electrode, electrode assembly or electrochemical cell comprising a surface-modified alkali metal material in accordance with the invention.

### DETAILED DESCRIPTION

In an aspect and various embodiments of the invention, the surface-modified alkali metal material for electrochemical use is made by a method comprising bringing a barrier agent into frictional contact with an alkali metal substrate to form the tribochemical barrier layer on the substrate.

The barrier agent may comprise any material capable of forming the tribochemical barrier layer upon being brought into frictional contact with the alkali metal substrate.

In various embodiments, the barrier agent and/or tribochemical barrier layer may include one or more materials that capable of conducting ions derived from the alkali metal substrate.

Suitably, the barrier agent may be metallic, i.e. comprise or optionally consist of one or more metals. Additionally, or alternatively, the barrier agent may be non-metallic, i.e. comprise or optionally consist of one or more non-metals.

Suitably, the barrier agent may be capable of forming an alloy or compound with at least a part of the alkali metal substrate.

In various embodiments, the barrier agent may comprise a metal compound, optionally an alkali metal compound.

In various embodiments, the barrier agent may comprise Li₃N, Si, Zn, Al, C, S, P₂S₅, SiS₂, Li₂S, Li₃PS₄, Li₃PO₄ or combinations thereof. Advantageously, the barrier agent may comprise Si and/or Li₃N.

Advantageously, the barrier agent may be particulate. This enhances the surface area of the barrier agent and facilitates frictional engagement and tribochemical mechanisms.

Advantageously, the particle size of the barrier agent may be selected so as not to change the mechanical continuity of the substrate.

Suitably, the volume-based average particle size of the barrier agent may be in the range of from a fifth or a tenth of the thickness of the substrate.

In various embodiments, the average or median particle size may be in the range of from 0.5 to 50 μm, such as in the range of from 1 to 30 μm, or even in the range of from 2 to 20 μm, e.g. 5 to 15 μm.

An average or median particle size may be determined on a volume basis.

Frictional contact can be achieved in a variety of ways. The barrier agent may be moved towards the substrate, or vice versa, or both.

Conditions for achieving an adherent coating on the alkali metal substrate may vary to a degree depending on the chosen alkali metal substrate and the barrier agent.

In general, bringing the barrier agent into frictional contact with the substrate may comprise forcing together the barrier agent and the substrate. Conveniently, the barrier agent and one or more planar faces of the substrate may be forced together.

In various embodiments, the barrier agent and the substrate may be forced together with a force in the range of from 0.1 to 1.0 kg/cm² substrate, optionally in the range of from 0.2 to 0.8 kg/cm², or even in the range of from 0.3 to 0.7 kg/cm².

Additionally, or alternatively, bringing the barrier agent into frictional contact with the substrate may comprise sliding or rubbing between the barrier agent and the substrate, optionally whilst the barrier agent and the substrate are forced together. Conveniently, the method may comprise sliding or rubbing between the barrier agent and one or more planar faces of the substrate.

In various embodiments, sliding or rubbing between the barrier agent and the substrate may be performed with a reciprocating motion.

Optionally, the reciprocating motion may have an amplitude in the range of from 1 to 5 mm and/or a frequency in the range of from 0.1 to 10 Hz.

In various embodiments, the barrier agent and the substrate may be slid or rubbed together for a period in the range of from 2 to 10 minutes. Suitably, the period may be 3 to 8 minutes, for example 4 to 7 minutes.

Advantageously, the substrate may be affixed and an applicator may be employed to force the barrier agent against the substrate and optionally to slide or rub the barrier agent along the substrate (optionally whilst continuing to force the barrier agent against the substrate). The applicator may comprise a smooth or roughened application surface. One example of a suitable applicator is a plate.

Conveniently, the substrate may be sheet-like and affixed onto a flat surface with one planar face exposed. The barrier agent may then be forced and optionally slid or rubbed against the exposed face, for example using an applicator.

Conveniently, bringing the barrier agent into frictional contact with the substrate may additionally or alternatively comprise impinging a stream of fluid bearing the barrier agent onto the substrate. Suitably, the fluid may pressurised. Conveniently, the fluid may be a gas.

Alkali metal is prone to passivation. Accordingly, the method may comprise removing a passivation layer from the alkali metal substrate. This may suitably be done before bringing the barrier agent into frictional contact with the substrate.

To prevent or mitigate passivation the method may be performed in a suitably inert atmosphere. Optionally, the atmosphere may comprise or consist essentially of argon.

However, it has surprisingly been found that the method can also be performed in an atmosphere comprising nitrogen or dry air.

Advantageously, the frictional contact may take place in the absence of solvents or additives.

Alternatively, the frictional contact may take place in the presence of one or more solvents or additives. Suitable additives may include monomeric species capable of polymerisation on contact with the alkali metal substrate. Examples of suitable solvents or additives include dioxolane, ketones, ethers, and unsaturated compounds.

The alkali metal substrate employed in aspects and embodiments of the invention comprises alkali metal and, optionally, a support. The alkali metal substrate may consist of metal/alloy or may be a composite comprising alkali metal.

The alkali metal may advantageously comprise lithium, sodium, lithium alloy, solidum alloy, potassium, potassium alloy, or combinations thereof. Preferably, the alkali metal may comprise or consist of lithium metal or a lithium alloy. In one embodiment, the alkali metal consists essentially of lithium.

Conveniently, the alkali metal substrate may comprise or consist of a foil of the alkali metal.

Where present, the support of the alkali metal substrate may provide additional mechanical stability thereto. Suitably, the support may be polymeric. Advantageously, the support may be fibrous, for example a non-woven material. The alkali metal may be deposited onto the support, for example as described in WO/2016/122353. Additionally, or alternatively, the alkali metal may be calendared onto or into the support.

In various embodiments, the alkali metal support may be permeable with through-pores. Alternatively, the alkali metal support may be impermeable without through-pores.

Suitably, the alkali metal substrate may be sheet-like with opposed planar faces defining a thickness therebetween. Advantageously, a thickness defined between opposed faces of the alkali metal substrate may be in the range of from 1 to 500 μm, such as in the range of from 10 to 150 μm, or even in the range of from 15 to 80 μm.

Optionally, the alkali metal substrate may comprise one or more connectors or collectors for electrochemical connection, e.g. in an electrochemical cell. The alkali metal substrate may thus constitute an electrode.

The tribochemical barrier layer is an adherent coating that results from frictional contact of the substrate with a barrier agent. The barrier layer may be formed as a result of mechanical or chemical phenomena, or a combination thereof.

The barrier layer may of course comprise a barrier agent as defined anywhere herein. Additionally, or alternatively, the barrier layer may comprise a tribochemical product derived from the barrier agent.

In various embodiments, the barrier layer has a thickness in the range of from 0.5 to 10 microns. Suitably, the thickness may be in the range of from 1 to 8 microns, for example in the range of from 2 to 5 microns.

Advantageously, the barrier layer may cover substantially the entirety of the substrate.

In various embodiments, the substrate may be sheet-like with opposed faces and the barrier layer may be applied to one or both faces.

Suitably, the barrier layer may be continuous, although an intermittent barrier layer may also be of use in some embodiments.

Throughout the description and claims of this specification, the words “comprise” and “contain” and variations of the words, for example “comprising” and “comprises”, mean “including but not limited to”, and do not exclude other components, integers or steps. Moreover, the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application it is expressly intended that the various aspects, embodiments, examples and alternatives set out in the preceding paragraphs, in the claims and/or in the following description, and in particular the individual features thereof, may be taken independently or in any combination. That is, all embodiments and/or features of any embodiment can be combined in any way and/or combination, unless such features are incompatible.

To further illustrate the invention, one or more non-limiting embodiments of the invention will now be described in the following experimental section with reference to the accompanying drawings in which:

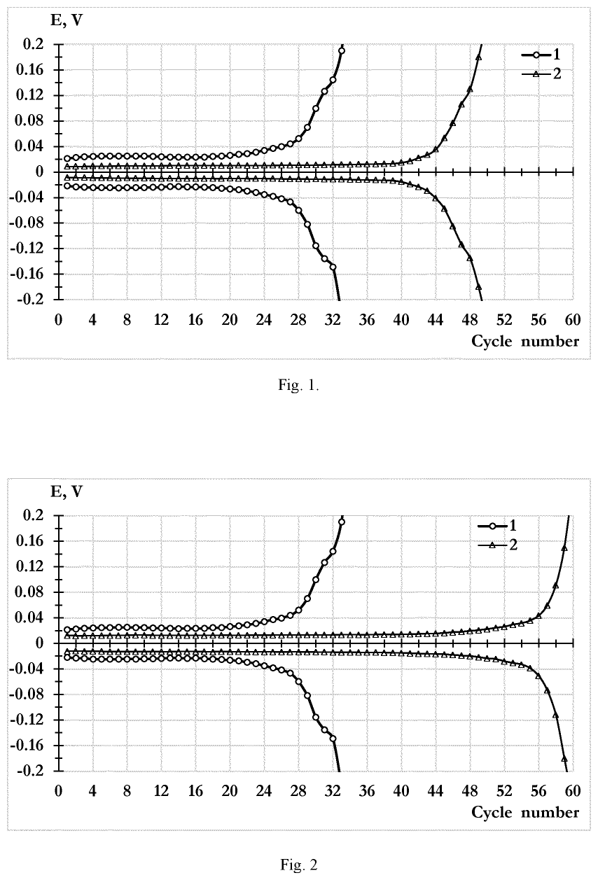

FIG. 1 shows a change in overpotential (E) of electrode processes during cycling of lithium electrodes without a barrier layer (1) and with a barrier layer (2) formed by the treatment with Si powder in a dry air atmosphere, at current density of 0.2 mA/cm² and depth of charge-discharge of 1.0 mAh/cm²;

FIG. 2 shows a change in overpotential (E) of electrode processes during cycling of lithium electrodes without a barrier layer (1) and with a barrier layer (2) formed by the treatment with Li₃N powder in a nitrogen atmosphere, at current density of 0.2 mA/cm² and depth of charge-discharge of 1.0 mAh/cm²;

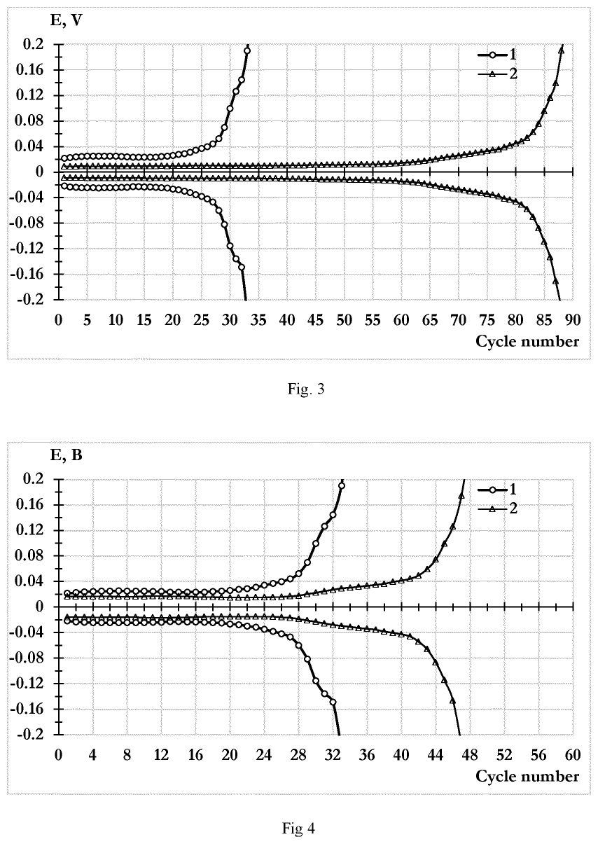

FIG. 3 shows a change in overpotential (E) of electrode processes during cycling of lithium electrodes without a barrier layer (1) and with a barrier layer (2) formed by a mixture of Si and Li₃N powders (2) in a nitrogen atmosphere, at current density of 0.2 mA/cm² and a charge-discharge depth of 1.0 mAh/cm²;

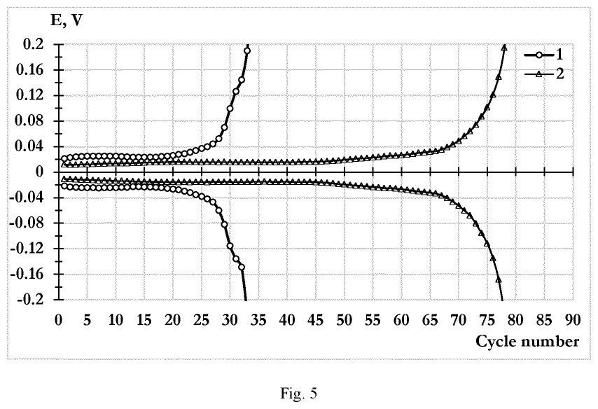

FIG. 4 shows a change in overpotential (E) of electrode processes during cycling lithium electrodes without a barrier layer (1) and with a barrier layer (2) formed by the treatment of Si powder in an atmosphere of argon, at a current density of 0.2 mA/cm² and a charge-discharge depth of 1.0 mAh/cm²; and

FIG. 5 shows a change in overpotential (E) of electrode processes when lithium electrodes are cycled without a barrier layer (1) and with a barrier layer formed by the treatment of P2S5 (2) powder in the nitrogen atmosphere, at a current density of 0.2 mA/cm² and a charge-discharge depth of 1.0 mAh/cm².

### EXAMPLE 0

Lithium foil is treated in a glove-box under argon, or nitrogen, or in a dry room. Metallic lithium foil is positioned on a flat surface of a material neutral to lithium, such as stainless steel. The surface of lithium is prepared by removing any possible contamination from its surface. A simple brush can be used for that purpose. After that a layer of powder material such as Si or Li₃N is applied on the surface in a thin even layer. To initiate a tribochemical reaction a stainless-steel plate is applied and moved across the surface in a reciprocating way. The surface of the stainless-steel plate can have different level of roughness to provide more efficient conditions for tribochemical reaction on the surface of metallic lithium. The friction energy of movement is thus transferred into tribochemical treatment of lithium. The processing time could take from 0.5 to 10 min with the pressure between the stainless-steel plate and lithium foil being in the range from 0.01 to 1 kg/cm².

### EXAMPLE 1

Barrier Layer by Tribochemical Treatment with Si Powder—Dry Air Atmosphere

All work on tribochemical treatment of the surface of lithium foil with silicon was carried out in a glove box in the atmosphere of dry air. The H₂O content was in the range of 20 to 40 ppm. A lithium foil with a thickness of 100 microns was placed on the surface of a stainless steel plate and secured. Then, the surface of metallic lithium was mechanically cleaned by using a stainless steel brush and/or scraper. After removing contaminants from the lithium surface, a uniform layer of silicon powder was applied. The median volume size of the Si particles was estimated to be in the range of from 5 to 15 microns. On the surface of the lithium foil with a layer of silicon powder was laid a stainless steel plate with a rough surface. To carry out the tribochemical reaction between metallic lithium and silicon powder, the rough plate was pressed to lithium foil with a pressure of 0.1-0.2 kg/cm² and brought in a reciprocal and progressive movement with amplitude of 1-5 mm and a frequency of 1-10 Hz. The resulting tribochemical reaction (tribochemical treatment of lithium foil) was carried out for 2-3 minutes.

After tribochemical treatment, the powder of unresponsive silicon was removed from the surface of the lithium foil. After tribochemical treatment, the surface of the lithium foil was dark grey. The thickness of the surface layer was assessed by weight by the difference in the mass of lithium foil before and after the tribochemical treatment. The thickness of the formed barrier layer was 1.5 microns.

Electrodes of the right size were cut from lithium foil with a barrier layer and they were further pressed through plastic film at a pressure of 100 kg/cm².

Symmetrical lithium cells (Li/electrolyte/Li) were then assembled from the resulting lithium electrodes. Also for comparison we assembled similar symmetrical cells but with lithium electrodes without a barrier layer.

Two layers of Celgard separator 3501 were used. The electrolyte was a solution 1.0M LiClO4 in sulfolane (SI). The galvanostatic polarization of the cells was carried out at a temperature of 30 C. The voltage range at cathodic and anodic polarization was limited by +/−500 uV with the current density being 0.2 mA/cm2.

The amount of electricity in cathodic deposition and/or anodic dissolution of lithium was equal to 1.0 mAh/cm2.

Studies have shown (FIG. 1) that cells with lithium electrodes with barrier layers formed on lithium by tribochemical treatment using silicon in the atmosphere of dry air, demonstrate more stable and prolonged cycling as well as significant reduction in overvoltage compared to cells with lithium electrodes without a barrier layer. This indicates that the tribochemical treatment of lithium foil by silicon produces a barrier layer significantly improves the electrochemical characteristics of the lithium electrode.

### EXAMPLE 2

Barrier Layer by Tribochemical Treatment with Li₃N Powder—Nitrogen Atmosphere

The formation of the Li₃N barrier layer was carried out in a similar way described in Example 1, except that the treatment of the surface of lithium foil was carried out in an airtight reactor under nitrogen, which was purged by nitrogen gas at a speed of 6 l/min.

The median volume size of the particles in the Li₃N powder (used instead of the powder of Example 1) was estimated to be in the range of from 5 to 15 microns.

Studies have shown (FIG. 2) that cells with lithium electrodes with barrier layers formed in tribochemical treatment of lithium foil by lithium nitride in nitrogen atmosphere, demonstrate better stability in cycling and significantly less overvoltage compared to cells with lithium electrodes without a barrier layer. This indicates that the tribochemical treatment of lithium foil lithium by lithium nitride resulted in formation of a barrier layer, significantly improving the electrochemical characteristics of the lithium electrode.

### EXAMPLE 3

Barrier Layer by Tribochemical Treatment with a Mixture of Si and Li₃N Powder—Nitrogen Atmosphere

A barrier layer of Si—Li₃N was formed in a similar way as described in Example 2.

The median volume size of the particles in the Si and Li₃N powder (used instead of the particles of Example 2) was estimated to be in the range of from 5 to 15 microns.

Studies have shown (FIG. 3) that cells with lithium electrodes with barrier layers formed in tribochemical treatment of lithium foil with a mixture of silicon and lithium nitride powders under nitrogen atmosphere, demonstrate more stable cycling and lower overpotential compared to cells with lithium electrodes without a barrier layer. This indicates that the tribochemical treatment of lithium foil with a mixture of silicon and lithium nitride powders formed a barrier layer, which significantly improved the electrochemical characteristics of the lithium electrode.

### EXAMPLE 4

Barrier Layer by Tribochemical Treatment with Si Powder—Argon Atmosphere

The formation of the Si barrier layer was carried out in a similar way as described in Example 2, except that the treatment of the surface of lithium foil was carried out in an airtight reactor under dry argon atmosphere.

The median volume size of the particles in the Si powder (used instead of the particles of Example 2) was estimated to be in the range of from 5 to 15 microns.

Studies have shown (FIG. 4) that cells with lithium electrodes with barrier layers formed by tribochemical treatment of lithium foil with silicon under argon atmosphere demonstrate more stable cycling and significantly lower overpotential compared to cells with lithium electrodes without a barrier layer. This indicates that the tribochemical treatment of lithium foil with silicon resulted in formation of a barrier layer, significantly improving the electrochemical characteristics of the lithium electrode.

### EXAMPLE 5

Barrier Layer by Tribochemical Treatment with P₂S₅ Powder—Nitrogen Atmosphere

The formation of the P₂S₅ barrier layer was carried out in a similar way as described in Example 2.

The median volume size of the P₂S₅ powder (used instead of the particles of Example 2) was estimated to be in the range of from 5 to 15 microns.

Studies have shown (FIG. 5) that cells with lithium electrodes with barrier layers formed in the tribochemical treatment of lithium foil with phosphorus sulfide in the nitrogen atmosphere, demonstrate more stable cycling and lower overpotential as compared to cells with lithium electrodes without a barrier layer. This indicates that the tribochemical treatment of lithium foil lithium with phosphorus sulfide formed a barrier layer, which significantly improved the electrochemical characteristics of the lithium electrode.

1. A method of making a surface-modified alkali metal material for electrochemical use, the method comprising bringing an alkali metal substrate into frictional contact with a barrier agent to form a tribochemical barrier layer on the substrate.

2. The method of claim 1, wherein the barrier agent and/or tribochemical barrier layer comprises a material capable of conducting ions derived from the alkali metal substrate.

3. The method of claim 1 or claim 2, wherein the barrier agent is selected from a metal or metal compound, a non-metal or non-metal compound, or combinations thereof.

4. The method of any preceding claim, wherein the barrier agent comprises Li₃N, Si, Zn, Al, C, S, P₂S₅, SiS₂, Li₂S, Li₃PS₄, Li₃PO₄ or combinations thereof.

5. The method of any preceding claim, wherein the barrier agent is particulate, optionally with a particle size in the range of from a fifth or a tenth of the thickness of the substrate.

6. The method of any preceding claim, wherein bringing the barrier agent into frictional contact with the substrate comprises forcing together the barrier agent and the substrate.

7. The method of any preceding claim, wherein the barrier agent and the substrate are forced together with a force in the range of from 0.1 to 1.0 kg/cm² substrate.

8. The method of any preceding claim, wherein bringing the barrier agent into frictional contact with the substrate comprises sliding or rubbing between the barrier agent and the substrate, optionally whilst the barrier agent and the substrate are forced together, optionally with a reciprocating motion.

9. The method of claim 8, wherein the reciprocating motion has an amplitude in the range of from 1 to 5 mm and/or a frequency in the range of from 0.1 to 10 Hz.

10. The method of claim 8 or claim 9, wherein the barrier agent and the substrate are slid or rubbed together for a period in the range of from 2 to 10 minutes.

11. The method of any one of claims 9 to 11 wherein the substrate is affixed and an applicator is employed to force the barrier agent against the substrate and optionally to slide or rub the barrier agent along the substrate, optionally whilst continuing to force the barrier agent against the substrate.

12. The method of any preceding claim, wherein bringing the barrier agent into frictional contact with the substrate comprises impinging a stream of pressurised fluid bearing the barrier agent onto the substrate.

13. The method of any preceding claim, comprising removing a passivation layer from the alkali metal substrate.

14. The method of any preceding claim performed in an inert atmosphere optionally consisting essentially of argon and/or comprising nitrogen or dry air.

15. The method of any preceding claim, wherein the frictional contact takes place in the absence of solvents or additives.

16. The method of any preceding claim wherein the alkali metal substrate comprises or consists of lithium metal or a lithium alloy.

17. The method of any preceding claim, wherein the alkali metal substrate comprises or consists of a foil of the alkali metal and/or wherein the alkali metal substrate comprises a polymeric support.

18. The method of any preceding claim, wherein the barrier layer has a thickness in the range of from 0.5 to 10 microns.

19. The method of any preceding claim, wherein the barrier layer covers substantially the entirety of the substrate.

20. The method of any preceding claim, wherein the substrate is sheet-like with opposed faces and the barrier layer is applied to one or both faces.

21. A surface-modified alkali metal material obtainable by any method according to any preceding claim.

22. A surface-modified alkali metal material for electrochemical use, the material comprising an alkali metal substrate bearing a tribochemical barrier layer.

23. The surface-modified alkali metal material of claim 22, wherein the alkali metal substrate and/or tribochemical barrier layer are as defined in any of claims 16 to 20.

24. An electrode, electrode assembly or electrochemical cell comprising a surface-modified alkali metal material according to any one of claims 21 to 23.

25. An electrochemical cell according to claim 24, wherein the cell is a primary or a secondary cell.
